(19) United States
(12) Patent Application Publication
(10) Pub. No.: US 2015/0106704 A1
(43) Pub. Date: Apr. 16, 2015

(54) ADAPTIVE GRAMMAR INSTRUCTION FOR SUBJECT VERB AGREEMENT

(71) Applicant: Apollo Education Group, Inc., Phoenix, AZ (US)

(72) Inventors: Brendon Towle, Los Angeles, CA (US); Annalies Vuong, Pittsburgh, PA (US); Karl Schaefer, Pittsburgh, PA (US)

(21) Appl. No.: 14/326,315

(22) Filed: Jul. 8, 2014

Related U.S. Application Data
(60) Provisional application No. 61/890,875, filed on Oct. 15, 2013.

(51) Int. Cl. G06F 17/24; G09B 7/00; G06F 3/0484; G06F 17/27; G06F 17/28

(52) U.S. Cl. CPC G06F 17/24; G06F 17/274; G06F 17/28; G06F 3/0484; G09B 7/00
USPC 715/271

(57) ABSTRACT

Techniques are described for an automated grammar teaching system that displays sentences and allows a user to identify subject-verb agreement errors within the sentences, if any. The sentences may be presented as single sentences or as part of a paragraph. The user may be asked to determine whether the sentences are correct or incorrect, to identify the locations of verbs that should agree with a subject of the sentence, to identify the core noun that determines whether the subject is singular or plural, and to provide a new verb that agrees with the subject. To guide the user, user responses may trigger the display of remediation information, which may include identifying one or more grammar elements of the sentences that are relevant to identifying the subject-verb agreement errors. New sentences in the teaching system may be selected based on historical data maintained for the user.

### CROSS-REFERENCE TO RELATED APPLICATIONS; BENEFIT CLAIM

This application claims the benefit of U.S. Provisional Application No. 61/890,875, filed Oct. 15, 2013, which is hereby incorporated by reference in its entirety for all purposes as if fully set forth herein.

### FIELD OF THE INVENTION

The present invention relates to teaching natural language rules of grammar, and, more specifically, to an adaptive grammar teaching system configured to train users on identifying and correcting subject-verb agreement errors within natural language sentences.

### BACKGROUND

Natural languages are spoken languages (such as American English), which have grammar rules governing the composition of the natural language. When a person has not learned the proper rules of grammar for a natural language, the student encounters difficulty in communicating using the natural language. For example, it may be particularly difficult for a person that does not understand the grammatical rules of American English to write an error-free research paper or formal letter, which limits that person's ability to communicate effectively through writing.

Grammar checkers, e.g., Grammerly.com, Thelma Thistleblossom, and grammar checkers included with document editors such as Microsoft Word, identify certain types of grammatical errors in written documents. However, grammar error identification/correction is not the same as teaching grammar rules, even when the grammar checker indicates why each identified error is an error. Thus, grammar checkers generally do not teach the rules of grammar, nor do grammar checkers target particular problems that users have with grammatical rules. At times, the grammar checkers identify “errors” that are not grammatical errors at all, and rely on the knowledge of the user to ultimately determine whether an error exists. Thus, grammar checkers are generally ineffective at teaching a user the rules of grammar of a natural language.

Some English courses, e.g., in secondary and higher education, attempt to teach the rules of natural language grammar, largely using face-to-face teaching techniques, quizzes, and other activities. At times, automation is used in such traditional English courses. However, this automation generally consists of providing a student with multiple-choice questions and giving the student feedback on the student's selected answers. It can be difficult for an English teacher to identify and aid each student with the students' individual grammar misconceptions, especially since classes tend to be large and students tend to have a wide range of skill gaps with respect to mastery of English grammar rules. At least the above mentioned deficiencies can allow students to complete English courses without learning all of the natural language grammar rules that they need to produce error-free communications.

Therefore, it would be beneficial to provide an automated grammar teaching system that is configured to teach natural language grammar concepts targeted to the needs of students.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example network arrangement for an automated grammar teaching system that adaptively instructs a user regarding grammar rules governing subject-verb agreement in sentences.

FIG. 2 depicts a flowchart for receiving input information from a user identifying subject-verb agreement errors in a displayed natural language sentence.

FIG. 3A, FIG. 3B, and FIG. 3C depict a graphical user interface configured to allow a user to identify, within a displayed sentence, subject-verb agreement errors.

FIG. 4 depicts a flowchart for receiving input information from a user identifying a correction of a subject-verb agreement error in a displayed natural language sentence and determining whether the correction is accurate.

FIG. 5A and FIG. 5B depict a graphical user interface configured to allow a user to identify a correction of a subject-verb agreement error within a displayed sentence.

FIG. 6 is a block diagram of a computer system on which embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

An automated grammar teaching system delivers highly personalized, differentiated instruction to users. The automated grammar teaching system provides lessons and adaptive practice to build each student's skills for the rules of natural language grammar with respect to subject-verb agreement. Subject-verb agreement problems are automatically presented to students by the automated grammar teaching system, and are constructed to address each student's continuous learning needs with respect to granular grammar skills relating to subject-verb agreement.

According to one embodiment, subject-verb agreement problems are presented, using a user interface, to a user. The problems may be presented as 1) single sentences, or 2) a paragraph having multiple sentences. For single sentences, it is stated that a subject-verb agreement error is present, and the user is then asked to 1) locate the verb that does not agree with the subject, 2) select the word, from the identified subject, that determines whether the subject is singular or plural, 3) determine whether the subject is singular or plural, based on the selected word, and/or 4) correct the verb so that it agrees with the subject. When the problem is presented as a paragraph of sentences, the user may be also asked to identify whether a sentence has a subject-verb agreement error or is correct as-is.

In an embodiment, if a user incorrectly identifies a particular portion or an entirety of a sentence as having a subject-verb agreement error, then the system displays remediation information to help the user understand why the identification is incorrect. In an embodiment, if a user provides an inaccurate correction to a subject-verb agreement error, the system displays remediation information to explain why the correction that the user specified is inaccurate. Further, the automated grammar teaching system records, as historical data, a user's actions within the system. The system uses this historical data to identify what sentences, with what kinds of subject-verb agreement errors, the system should provide to the user.

### Adaptive grammar Instructions Architecture

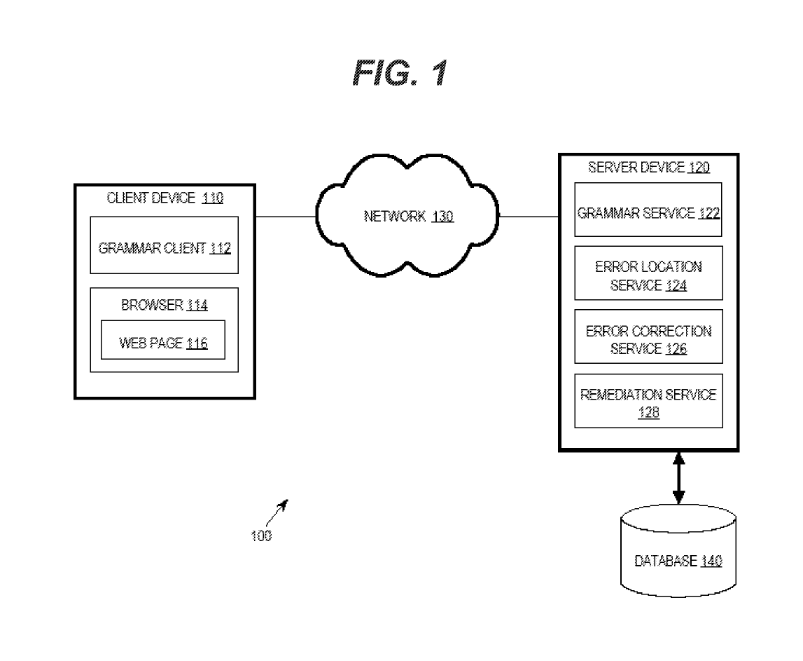

Techniques are described hereafter for adaptively instructing a user on grammar rules governing subject-verb agreement usage in sentences. FIG. 1 is a block diagram that depicts an example network arrangement 100 for an automated grammar teaching system that adaptively instructs a user regarding grammar rules governing subject-verb agreement usage in sentences, according to embodiments. Network arrangement 100 includes a client device 110 and a server device 120 communicatively coupled via a network 130. Server device 120 is also communicatively coupled to a database 140. Example network arrangement 100 may include other devices, including client devices, server devices, and display devices, according to embodiments. For example, one or more of the services attributed to server device 120 herein may run on other server devices that are communicatively coupled to network 130.

With respect to FIG. 1, server device 120 may correspond to server device 120 from FIG. 1.1 of the parent provisional application, as described in Section 1.0 of the parent provisional application. Accordingly, additional services such as mastery tracking service 124 and hint service 126 from service device 120 in FIG. 1.1 of the parent provisional application may also be included in server device 120 of FIG. 1.

Client device 110 may be implemented by any type of computing device that is communicatively connected to network 130. Example implementations of client device 110 include, without limitation, workstations, personal computers, laptop computers, personal digital assistants (PDAs), tablet computers, cellular telephony devices such as smart phones, and any other type of computing device.

In network arrangement 100, client device 110 is configured with a grammar client 112 and a browser 114 that displays web page 116. Grammar client 112 may be implemented in any number of ways, including as a plug-in to browser 114, as an application running in connection with web page 116, as a stand-alone application running on client device 110, etc. Grammar client 112 may be implemented by one or more logical modules, and is described in further detail below. Browser 114 is configured to interpret and display web pages that are received over network 130 (e.g., web page 116), such as Hyper Text Markup Language (HTML) pages, and eXtensible Markup Language (XML) pages, etc. Client device 110 may be configured with other mechanisms, processes and functionalities, depending upon a particular implementation.

Further, client device 110 is communicatively coupled to a display device (not shown in FIG. 1), for displaying graphical user interfaces, such as graphical user interfaces of web page 116. Such a display device may be implemented by any type of device capable of displaying a graphical user interface. Example implementations of a display device include a monitor, a screen, a touch screen, a projector, a light display, a display of a tablet computer, a display of a telephony device, a television, etc.

Network 130 may be implemented with any type of medium and/or mechanism that facilitates the exchange of information between client device 110 and server device 120. Furthermore, network 130 may facilitate use of any type of communications protocol, and may be secured or unsecured, depending upon the requirements of a particular embodiment.

Server device 120 may be implemented by any type of computing device that is capable of communicating with client device 110 over network 130. In network arrangement 100, server device 120 is configured with a grammar service 122, an error location service 124, an error correction service 126, and a remediation service 128. One or more of services 122-128 may be part of a cloud computing service. Functionality attributed to one or more of services 122-128 may be performed by grammar client 112, according to embodiments. Services 122-128 may be implemented by one or more logical modules, and are described in further detail below. Server device 120 may be configured with other mechanisms, processes and functionalities, depending upon a particular implementation.

Server device 120 is communicatively coupled to database 140. Database 140 may reside in any type of storage, including volatile and non-volatile storage (e.g., random access memory (RAM), one or more hard or floppy disks, main memory, etc.), and may be implemented by multiple logical databases. The storage on which database 140 resides may be external or internal to server device 120.

Any of grammar client 112 and services 122-128 may receive and respond to Application Programming Interface (API) calls, Simple Object Access Protocol (SOAP) messages, requests via HyperText Transfer Protocol (HTTP), HyperText Transfer Protocol Secure (HTTPS), Simple Mail Transfer Protocol (SMTP), or any other kind of communication, e.g., from one of the other services 122-128 or grammar client 112. Further, any of grammar client 112 and services 122-128 may send one or more of the following over network 130 to one of the other entities: information via HTTP, HTTPS, SMTP, etc.; XML data; SOAP messages; API calls; and other communications according to embodiments.

In an embodiment, each of the processes described in connection with one or more of grammar client 112 and services 122-128 are performed automatically and may be implemented using one or more computer programs, other software elements, and/or digital logic in any of a general-purpose computer or a special-purpose computer, while performing data retrieval, transformation, and storage operations that involve interacting with and transforming the physical state of memory of the computer.

### Intelligent Tutoring System for Automatically Teaching Grammar

According to an embodiment, grammar service 122 and/or grammar client 112 is implemented as part of an intelligent tutoring system, such as the cognitive tutor described in Kenneth R. Koedinger, John R. Anderson, William H. Hadley, & Mary A. Mark Intelligent tutoring goes to school in the big city §2.2 (7th World Conference on Artificial Intelligence in Education 1995), which paper is incorporated herein by reference.

### Sentence Problems Stored at the Database

According to embodiments, a subject-verb agreement problem includes either (a) a single sentence or (b) a paragraph. A set of problem data may also include one or more of:
a problem type indicating a subject-verb agreement problem;
markup of a subject-verb agreement problem sentence (as described in further detail below);
information that may be presented as hints;
identifying all nouns, including the complete subject and the core nouns within the subject that determine whether the subject is singular or plural;
identifying all verbs, including the main verb and any verbs in dependent clauses;
for the main verb, identifying whether the main verb is singular or plural and listing one or more acceptable correction options;
structures in the sentence;
remediation information for incorrect answers, as necessary, including nouns that are gerunds, non-core nouns in the subject, and past tense variations of each verb;
a sentence structure type for affecting grammar skills, as discussed above in Section 1.0, including: 1) a collective noun as the subject with additional words between the subject and the verb; 2) a compound subject using “and”, 3) a compound subject using “or”, 4) a count noun as the subject with additional words between the subject and the verb, 5) a gerund phrase as the subject with additional words between the subject and the verb, 6) an indefinite pronoun without an object as the subject, 7) an indefinite pronoun as the subject with additional words between the subject and the verb, 8) a mass noun as the subject with additional words between the subject and the verb, 9) a sentence not falling into one of the above categories, 10) a sentence using “there is” or “there are”, and 11) a sentence having no subject-verb agreement error.

In some embodiments, some of the above metadata may not be explicitly specified by the problem writer. For example, if a sentence does not include any correction options for the main verb, then the sentence may automatically be categorized into sentence type 11, or a sentence with no error, without the problem writer having to explicitly specify as such in the metadata. In another example, the past tense variations of the verbs may be automatically generated by lookup or creation without requiring any manual intervention.

To illustrate, database 140 may include, in connection with a particular set of problem data, metadata embedded into the following marked-up sentence:
‘[_subject][_otherNoun]Some[/_otherNoun] of the most $successful [_otherNoun]business[/_otherNoun] [_coreWord]ventures[/_coreWord][/subject][_verb]begins[/_verb] with a SWOT [_otherNoun]analysis[/_otherNoun].’ verbNumber=‘_singular’),\

The embedded metadata variable (“$successful”) facilitates creating alternate wordings for the marked-up sentence. For example, database 140 also includes the following definitions of the embedded variable:
‘successful’:RandomChoiceGenerator(choices=[‘successful’, ‘effective’, ‘profitable’, ‘fruitful’, ‘rewarding’, ‘prosperous’]).
   According to an embodiment, the variables are resolved before the sentence is stored at database 140. Thus, the problems may be written with metadata to allow multiple alternative wordings. For example, by adding additional metadata variables, different nouns and verbs may be substituted as alternatives, subject-verb agreement may be correct or incorrect according to random selection, different phrases may be selected at random, and elements may be rearranged into different orders within the sentence, allowing a wide range of possible problem sentences and sentence types to be generated from a small amount of metadata.

According to an embodiment, metadata for a sentence includes a tag that grammar service 122 may use for remediation information. Such metadata identifies one or more portions of a sentence that are correct. For example, a particular marked-up sentence includes the metadata tag [_otherNoun/], which indicates to grammar service 122 that a noun unrelated to the main verb is located where the tag is positioned. As described in further detail below, remediation service 128 may use such metadata to identify particular remediation information to display to a user. For example, if a user selects the other noun as the noun that indicates whether the subject is singular or plural, then remediation service 128 uses the metadata tag to identify remediation text to display to the user. For example, the remediation text may indicate that the noun is unrelated to the main verb.

### Subject-Verb Agreement Problem Categories

According to an embodiment, subject-verb agreement errors in database 140 are authored to present one of the following two categories: (a) a single sentence that may include one or more subject-verb agreement errors, and (b) a paragraph with zero or more subject-verb agreement errors. The paragraph may correspond to a subset of a longer paragraph, and the subset may be selected to respect sentence dependencies within the longer paragraph. For example, if the second sentence in the longer paragraph refers to the first sentence, such as by using a phrase similar to “as discussed above”, then the subset is selected such that the first and second sentences are either selected or omitted together.

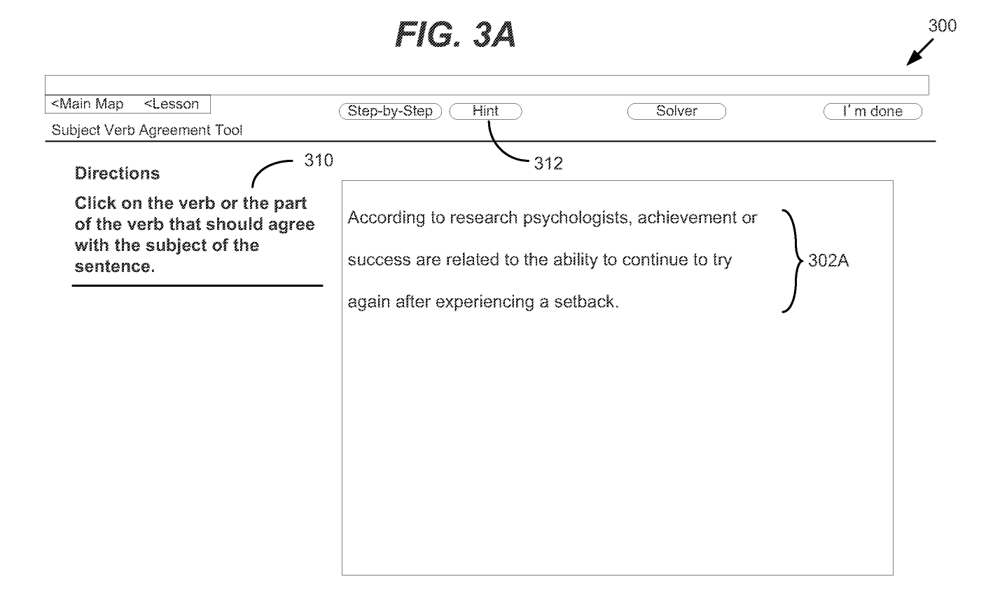

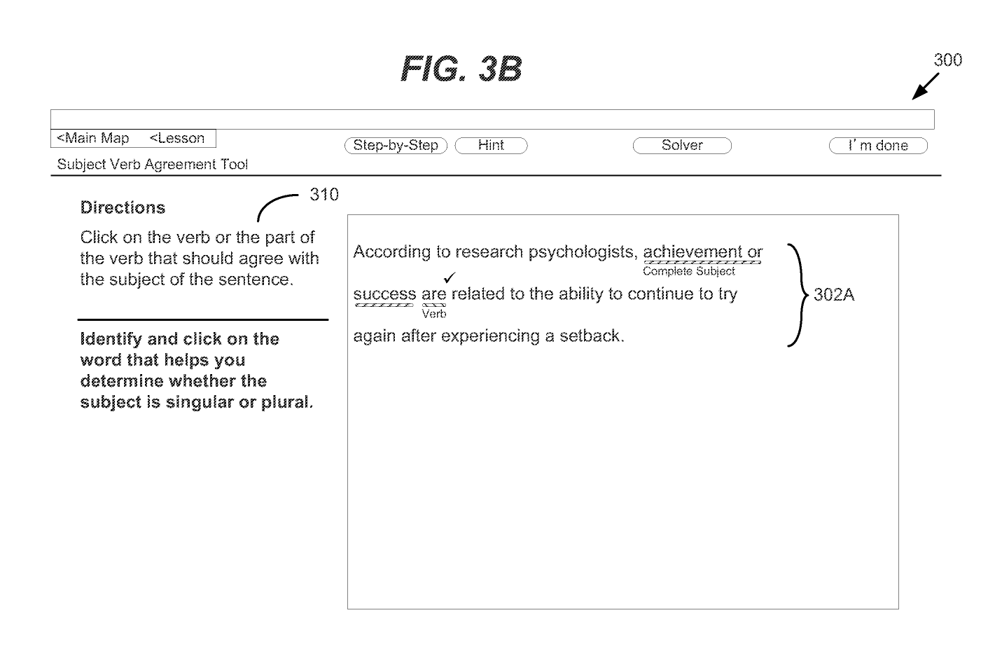

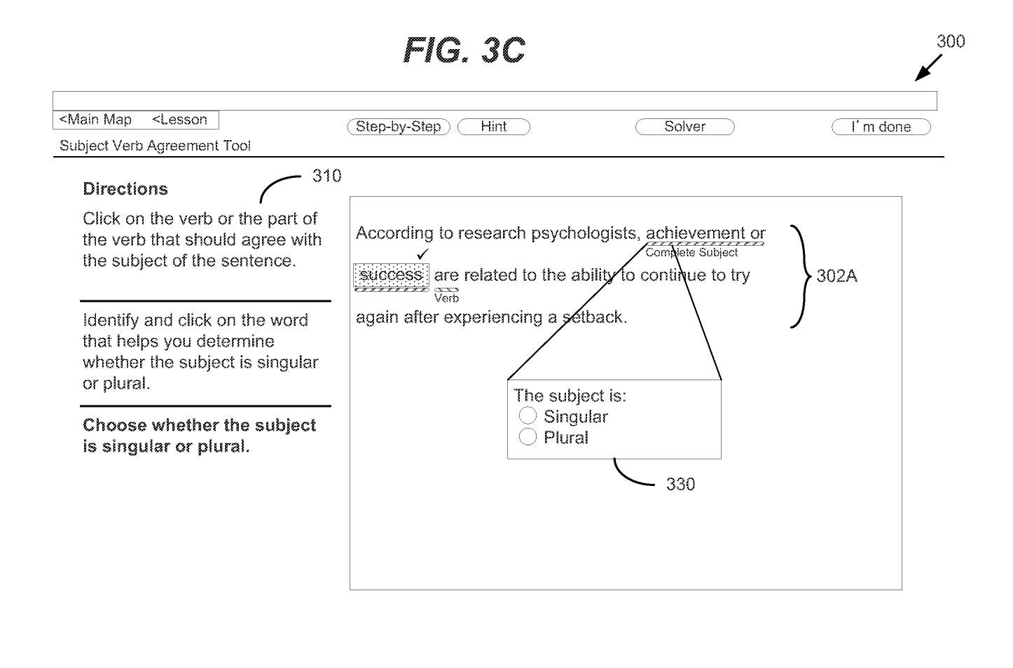

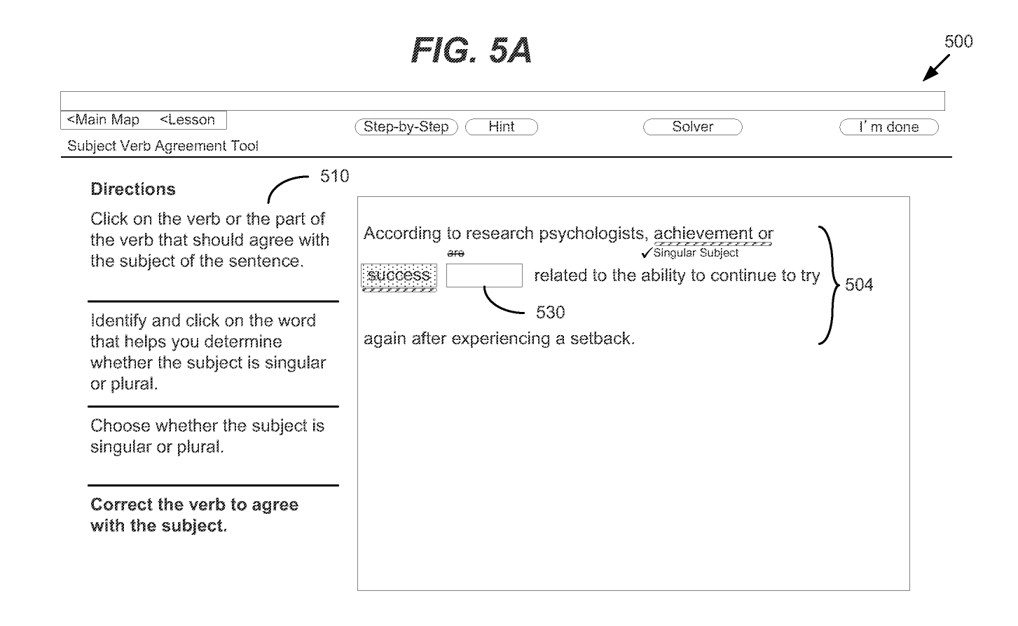

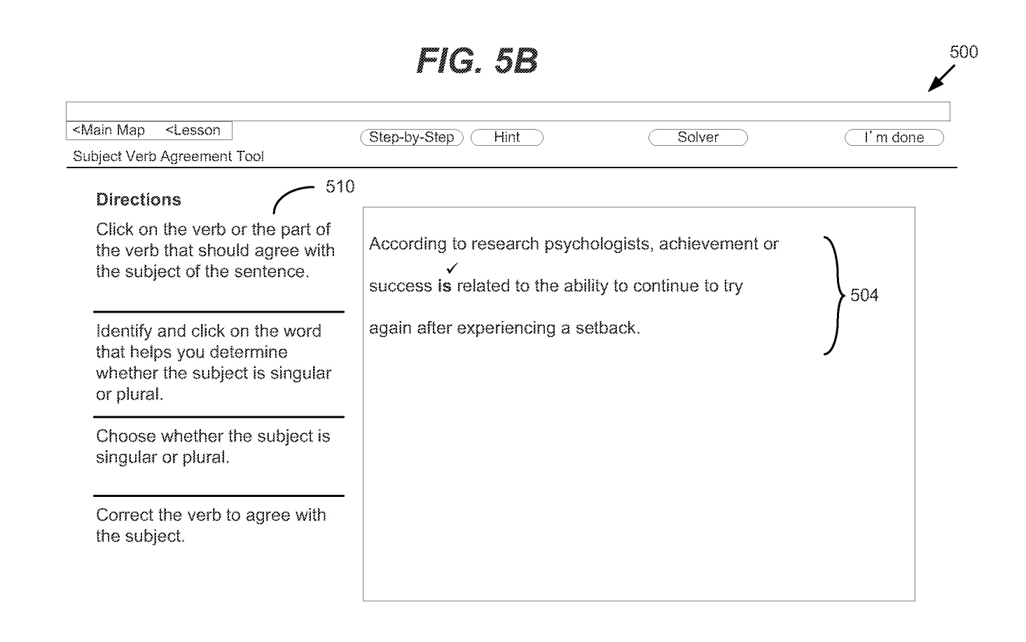

In each category of problems, the user may be asked to complete one or more tasks, including 1) identifying whether there is a subject-verb agreement error or not, 2) if there is a subject-verb agreement error, identifying the specific verb that has the error, 3) identifying the words of the subject that determine whether the subject is singular or plural, and 4) correcting the verb to agree with the subject. In some embodiments, it may be given that an error exists and task 1) may be skipped. Other problem structures for subject-verb agreement errors may also be presented to users within embodiments. As the user progress through the above tasks, instructions 310 and 510 as shown in FIG. 3A and FIG. 5A may be updated to reflect the current task at hand.

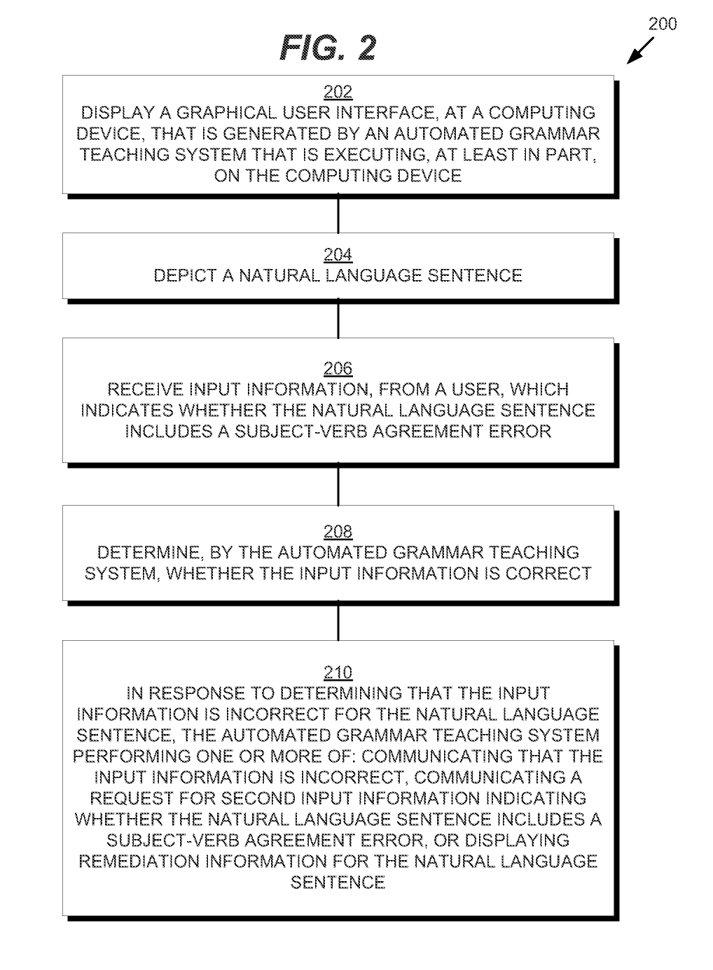

To identify the presence or absence of a subject-verb agreement error in step 1) above, the user may for example click on a yes/no dialog box presented in the user interface. In step 2), the verb to be corrected may be clicked or highlighted. Grammar service 122 may utilize error location service 124 to identify the specific locations in the sentences that require correction for subject-verb agreement, which may proceed similarly to the processes described in FIG. 2.2 and FIG. 2.3A-2.3B and related text in Section 2.0 of the parent provisional application.

### Graphical User Interface Displaying a Sentence

FIG. 2 depicts a flowchart 200 for receiving input information from a user identifying subject-verb agreement errors in a displayed natural language sentence. At step 202 of flowchart 200, a graphical user interface is displayed at a computing device, which graphical user interface is generated by an automated grammar teaching system that is executing, at least in part, on the computing device. For example, in FIG. 1, web page 116 includes a graphical user interface such as GUI 300 of FIG. 3A, which is generated by grammar service 122 executing on server device 120 or by grammar client 112 executing on client device 110.

Grammar service 122 sends information for GUI 300, via network 130, to grammar client 112. Grammar client 112 makes GUI 300 available to browser 114 executing on client device 110, and browser 114 displays GUI 300, i.e., in web page 116. According to another embodiment, grammar client 112 causes GUI 300 to be displayed outside of a browser, e.g., as part of a stand-alone application.

At step 204 of flowchart 200, a natural language sentence is depicted, which may include zero or more subject-verb agreement errors. To illustrate, GUI 300 depicts natural language sentence 302A that, according to an embodiment, includes a subject-verb agreement error, as stated by instructions 310. According to another embodiment, sentence 302A may or may not contain a subject-verb agreement error, and grammar client 112 instructs users to determine whether the sentence includes a subject-verb agreement error.

### Identifying Subject-verb Agreement Errors

At step 206, input information is received, from a user, which indicates whether the natural language sentence includes a subject-verb agreement error. For example, grammar client 112 receives information, input by the user via GUI 300 that indicates whether sentence 302A has no subject-verb agreement error or has a subject-verb agreement error, as discussed above. A user may indicate this in various ways, such as by clicking on a list of radio buttons, by entering a particular key stroke, etc. In some embodiments, it may be given that an error exists without requiring any user input.

FIG. 3 includes instructions 310 that instruct a user to identify the verb or the part of the verb in sentence 302A that is associated with the subject-verb agreement error. This depiction of instructions is non-limiting, and the instructions may be presented in other manners, with other wording, or may be entirely absent, within embodiments.

If a sentence includes multiple subject-verb agreement errors, then it is possible that the user needs to make corrections at two or more locations in order to correct the subject-verb agreement errors. Thus, embodiments may include sentences that have one or more subject-verb agreement errors, which may be identified and corrected by the user.

Assuming that there is only one subject-verb agreement error, the user may indicate the verb that is associated with the error by clicking the word. In some embodiments, selections may be made by highlighting rather than single clicking, for example by clicking and dragging the desired selection. Assuming the user has correctly identified the problematic verb as “are”, GUI 300 may transition to GUI 300 as shown in FIG. 3B. As shown in GUI 300, the complete subject and the verb are both identified for the user, and a checkmark is shown to confirm that the selected verb does indeed have a subject-verb agreement error.

Transitioning to GUI 300 in FIG. 3C, the user is further tasked to identify the word that determines whether the subject is singular or plural. As shown in FIG. 2C, the complete subject was already highlighted for the user, so the user only needs to pick the “core” noun from the complete subject, or “success”. In some embodiments, the complete subject may not be identified to the user; in these embodiments, the user may be asked to explicitly select the complete subject, or the user may be asked to simply select the core noun without an explicit indication of the subject. Once the noun “success” is selected, window 330 may appear, further tasking the user to choose whether the subject is singular or plural. While the example shown in FIG. 3C uses radio buttons for selection, various other input methods may also be supported. Assuming that the user correctly selects the “Singular” radio button, the user may be finally prompted to type in the correct verb, as discussed in conjunction with FIG. 5A and FIG. 5B below.

At step 208, the automated grammar teaching system determines whether the input information received from the user is correct. Assuming that the user correctly typed in the correction answer as “is”, grammar client 112 sends the information indicating the selected verb, the nouns that indicate whether the subject is singular or plural, the plurality of the subject, and the corrected verb to grammar service 122. Grammar service 122 employs error location service 124 and error correction service 126 to determine whether the user correctly identified the verb, subject, subject plurality, nouns indicating the subject plurality, and the corrected verb for the subject-verb agreement error. For example, error location service 124 and error correction service 126 may verify the user input as correct by referencing the metadata stored in database 140 for sentence 302A. Otherwise, if the user selects the wrong location or provides the wrong correction, then the user input may be determined as incorrect. Step 208 may be carried out after the user provides input information for each problem step or task, and the user may be prevented from proceeding further until the user answers each problem step or task successfully.

Returning to flowchart 200 of FIG. 2, at step 210, the automated grammar teaching system performs one or more of the following actions in response to determining that the indicated input information is incorrect for the sentence:
communicating that the indicated input information is incorrect;
communicating a request for second input information; or
displaying remediation information for the incorrectly indicated sentence.

For example, assume that the user has indicated that no errors are present in sentence 302A, and has clicked on the “I'm done” button. In this case, error correction service 126 receives input information indicating that the user has incorrectly identified that no subject-verb agreement errors exist for sentence 302A. As discussed above, these indications can be determined by examining the metadata in database 140.

According to an embodiment, in response to the above determination of error correction service 126, grammar client 112 communicates that the indicated input information is incorrect. For example, grammar client 112 displays text that informs the user that the user has not provided the correct selection for sentence 302A. As another example, grammar client 112 displays a symbol or plays a sound to indicate the incorrect selection for sentence 302A. As yet another example, grammar client 112 simply does not move on to another problem or another portion of the present problem, which communicates to the user that the user has not correctly selected the correct selection for sentence 302A.

According to another embodiment, in response to the above determination of error correction service 126, grammar client 112 communicates a request for second input information. For example, grammar client 112 displays text that requests that the user make another answer attempt. As another example, grammar client 112 highlights instructions 310 within GUI 300 (e.g., with bolded text, font color, highlight color, a displayed symbol, a displayed border, etc.).

### Hint Information

According to an embodiment, grammar client 112 displays remedial information in connection with communicating that the indicated response is incorrect. For example, assume the user selected the word “experiencing” to identify the verb. In response, a window may appear, advising the user that the verb is correct and to try selecting a different verb. According to another embodiment, grammar client 112 displays hint information in response to detecting selection of hint button 312 (in GUI 300 of FIG. 3A). Displayed hint information may be from one of various levels of hint information from the data for sentence 302A. Such levels may include (1) general instruction, (2) what concepts to think about for sentence 302A, and (3) what the correct answer is and why. Thus, as the user requests additional hints, the hints may progress from generalized rule statements to more specific instructions as applied to the specific problem at hand. The user may move forwards and backwards through the hints as desired.

Hints may also be presented in a contextually aware fashion. For example, hints may be tailored according to the specific portion or step of the problem that the user is working with. Additionally, in some embodiments, the hints may be provided proactively as a just-in-time intervention. For example, as discussed above, the metadata may identify nouns that are gerunds that might be mistaken for verbs. If the user lingers on a gerund when selecting the verb for correction, then a just-in-time tooltip may be shown, attempting to steer the user away from making the incorrect modification. For example, an explanation may be given why the gerund is actually a noun. In another embodiment, the remedial information may not be presented to the user until the incorrect selection has been made.

### Informal Hints

In some embodiments, less formalized hints may be given to assist the user. For example, some terms may be difficult to understand if the user is unfamiliar with formal grammar terminology. Thus, a less formalized explanation may be provided in the hints. As the user is exposed to formal grammar terminology, the hints may gradually transition to using formal terminology. Additionally, in some embodiments, an explanatory tooltip may be shown to the user when the user hovers over a particular term. For example, if the user places a cursor over the word “gerund”, a tooltip may appear with a definition of “gerund” and some examples. In other embodiments, the information may be presented in a separate glossary that is available to the user through the use of contextual links, right-click contextual menus, search, or other means of access.

### Correcting a Subject-Verb Agreement Error

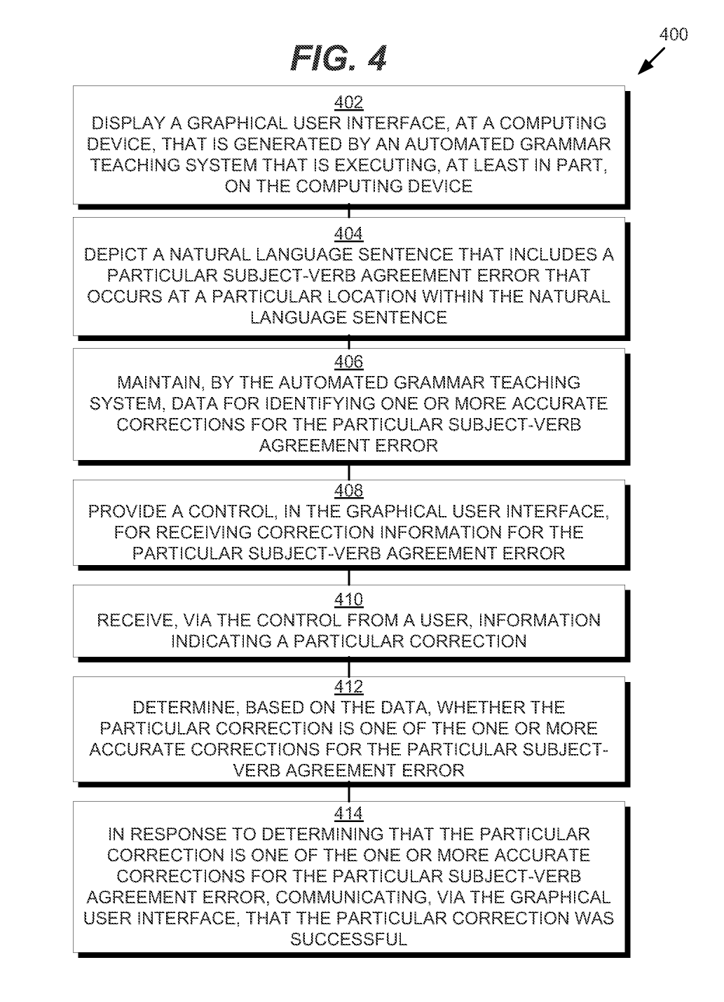

FIG. 4 depicts a flowchart 400 for receiving input information from a user identifying a correction of a subject-verb agreement error in a displayed natural language sentence and determining whether the correction is accurate. At step 402 of flowchart 400, a graphical user interface is displayed at a computing device, which graphical user interface is generated by an automated grammar teaching system that is executing, at least in part, on the computing device. For example, web page 116 includes a GUI such as GUI 500 of FIG. 5A, which is generated by grammar service 122 executing on server device 120 or by grammar client 112 executing on client device 110.

At step 404 of flowchart 400, a natural language sentence is depicted, which includes a subject-verb agreement error that occurs at a particular location within the natural language sentence. For example, GUI 500 depicts natural language sentence 504 that includes a subject-verb agreement error at the location contained within text box 530.

At step 406, the automated grammar teaching system maintains data for identifying one or more accurate corrections for the particular subject-verb agreement error. For example, database 140 includes a set of one or more accurate correction options for the particular subject-verb agreement error. To illustrate in the context of sentence 504, database 140 has information indicating that the following correction options are accurate for the subject-verb agreement error in sentence 302A:
The plural verb “are” at the location contained within text box 530 does not agree with the singular subject “achievement or success” and should be corrected by replacing with “is”.
   While only one possible correction option is listed above, some problems may include multiple valid correction options in the metadata of database 140.

At step 408, a control is provided, in the graphical user interface, for receiving correction information for the particular subject-verb agreement error. For example, grammar client 112 allows the user to type in a new verb within text box 530 after identifying that sentence 504 contains an incorrect verb at the location enclosed by text box 530.

At step 410, information indicating a particular correction is received via the control from a user. Assume the user correctly enters the correction of “is” within text box 530. Grammar client 112 receives information indicating that the user has submitted a correction of “is” and sends the information to grammar service 122.

At step 412, it is determined, based on the data, whether the particular correction is one of the one or more accurate corrections for the particular subject-verb agreement error. For example, grammar service 122 employs error correction service 126 to determine whether “is” corresponds to a valid correction for the subject-verb agreement error. Error correction service 126 thus examines the set of correction options, stored at database 140, that are accurate for the subject-verb agreement error in sentence 504.

Error correction service 126 compares “is” to each of the accurate correction options stored at database 140 in turn. In most cases, there will only be one accurate correction option, but in some cases multiple correct answers may be available. Since the metadata in database 140 may indicate that a valid correction is “is”, error correction service 126 determines that the particular correction is one of the accurate corrections. To provide some flexibility and to keep the focus on the substantive grammar rules, fuzzy searches or regular expressions may be supported to detect and ignore minor deviations such as spelling errors, incorrect capitalization, and excess whitespace. These deviations may be accepted as correct answers, with the corrected version shown to the user.

At step 414, in response to determining that the particular correction is one of the one or more accurate corrections for the particular subject-verb agreement error, it is communicated, via the graphical user interface, that the particular correction was successful. In response, grammar client 112 may display text that informs the user that the user has accurately corrected the subject-verb agreement error in sentence 504. As another example, grammar client 112 displays a symbol, such as a green checkmark, or plays a sound to indicate to the user that the user has accurately corrected the subject-verb agreement error within sentence 504. As shown when transitioning from GUI 500 in FIG. 5A to GUI 500 in FIG. 5B, the accurate correction is reflected by bolding the corrected verb, adding a checkmark, and graying out the corrected sentence. As yet another example, grammar client 112 simply moves on to another problem or another portion of the present problem, which communicates to the user that the user has accurately corrected the subject-verb agreement error within sentence 504. Additionally, instructions 510 may be updated to reflect the successful correction and provide directions for a new task, such as identifying subject-verb agreement errors in another sentence of a paragraph.

### Post Problem Rule Explanations

To help the user become familiar with formal grammar terminology and rules, rule explanations using formal grammar terminology may be provided after each successfully solved problem, even when informal hints are being provided. Rule explanations may be provided in the form of an on-screen character or avatar that coaches the user in a conversational style. After the user correctly answers a problem, the correct sentences may be displayed with the on-screen character commenting on the application of the rule.

### Remediation Information in Response to an Incorrect Selection

According to yet another embodiment, in response to the above determination of error correction service 126, grammar client 112 displays “remediation information” for the incorrectly indicated sentence. For example, remediation service 128 may use the metadata stored in database 140 to identify whether the verb, the noun determining the subject plurality, the subject plurality, or the corrected verb submitted by the user is incorrect and to determine whether associated remediation information is available. In an embodiment, grammar client 112 presents a user with targeted remediation information about mistakes made by the user in identifying subject-verb agreement errors. Information on why the identified sentence is incorrectly indicated educates the user on proper subject-verb agreement, and therefore reinforces the user's knowledge of how to properly form sentences with correct subject-verb agreement.

Remediation information includes information that explains to a user why a particular sentence is incorrectly identified as having or not having a subject-verb agreement error. According to an embodiment, database 140 stores remediation information, including text to be displayed, for each stored sentence. According to another embodiment, database 140 stores a collection of remediation information display text indexed by unique identifiers. In this embodiment, remediation information for a particular sentence includes unique identifiers of remediation information stored in the collection.

Remediation information is created based on one or more of (a) academic literature about what students know and the mistakes that students make, (b) what subject matter experts and/or cognitive scientists know about how students learn, and (c) analysis of historical data gathered by grammar service 122. For example, grammar service 122 records, in historical data for a user, the mistakes that the user makes in identifying and correcting subject-verb agreement errors, and what, if any, remediation information grammar client 112 was presented to the user in response to detecting the mistake. Trends in the historical data may be identified, e.g., by cognitive scientists, to determine what remediation information should be added to database 140.

Grammar client 112 displays remediation information when the user incorrectly identifies the presence or absence of a subject-verb agreement error for any of the sentences. As discussed above, this may be determined by examining metadata within database 140 for a sentence in question. Remediation information may be shown in a pop-up window, similar to remediation information 406 in GUI component 412 of FIG. 2.4, as discussed in Section 2.0 of the parent provisional application. For example, if the user types the wrong verb in text box 530, then remediation information 532 may appear. This information may appear as the user is typing, or only after the user submits the answer by clicking the “I'm done” button. The user may then proceed to retry the problem with a different verb. If the user is still confused, the user may request additional hints by clicking on the hint button, as described above.

According to this embodiment, database 140 contains remediation information for one or more of the following:
Identifying some other verb as the verb that does not agree with its subject;
Identifying “or” as the word that determines whether or not a subject is singular or plural;
Identifying the noun before “or” as the word that determines whether or not a subject is singular or plural;
Identifying some other noun as the word that determines whether or not a subject is singular or plural;
Identifying an instance of “and” that doesn't join a compound subject as the word that determines whether or not a subject is singular or plural;
Identifying a noun gerund as a verb;
Providing a past tense variation of a verb, as present tense may be preferable;
Identifying a noun in the complete subject that is not a core noun (this may not impose any penalties on user skill levels, as the noun may still be a valid answer, just not the particular answer the problem creator had in mind).

### Sequence of the Sentence Problem

According to an embodiment, grammar client 112 presents a control for receiving correction information for a sentence only in response to the user correctly identifying the location of a subject-verb agreement error within the sentence. According to another embodiment, a control for receiving correction information for a sentence is presented in response to either: the user identifying the correct location of the subject-verb agreement error within the sentence; or grammar client 112 displaying information showing, to the user, the correct location of the error.

For example, grammar client 112 displays information showing, to the user, the correct location of a subject-verb agreement error once the user has selected a threshold number of locations, within a displayed sentence, that do not substantially match the correct location of a subject-verb agreement error within the sentence. The user may be given a control to dismiss the information showing the correct location of the error; in such an embodiment, the control for receiving correction information is displayed in response to grammar client 112 detecting activation of the control to dismiss the information showing the correct location of the error.

According to another embodiment, grammar client 112 displays a control for receiving correction information for a sentence without requiring that the user correctly identify the location of a subject-verb agreement error within the sentence.

### tracking and Using Historical Data

Grammar service 122 identifies which problem to display to a user based, at least in part, on user information stored at database 140. According to an embodiment, the automated grammar teaching system in FIG. 2.1 of the parent provisional application is configured to maintain historical data for a user, e.g., in a user profile for the user stored at database 140. Such historical data includes one or more of: previous problems that have been presented to the user, types of previous problems that have been presented to the user, correct and incorrect answers given by the user, timing of viewing and answering presented questions, etc.

Based, at least in part, on the historical data, grammar service 122 identifies problems, to present to the user, that target concepts within the grammar rules governing sentence types with which the user has had trouble. The way that grammar service 122 interprets the data is configurable by an administrator of the system. For example, an administrator sets a rule in grammar service 122 that states that a user needs additional practice for a particular sentence type when the user misses over 50% of problems that feature the particular sentence type during the past seven days. At a certain point in time, the historical data for a particular user indicates that the user has made mistakes on a particular type of sentence 80% of the times that sentences of this type have been presented to the user in the past week. Based on this historical data and the administrator-set rule, grammar service 122 presents sentences of that type to the user at a higher rate than other types of sentences until grammar service 122 identifies that the rate of making mistakes on this type of problem is no longer over 50%.

According to embodiments:
1. A set of grammar skills that users are expected to master are identified, e.g., by cognitive scientists and/or subject matter experts;
2. Steps in individual problems are associated with particular grammar skills, e.g., by cognitive scientists and/or subject matter experts;
3. As the user progresses, the user's probability of mastery for each individual grammar skill is automatically calculated (according to Bayesian Knowledge Tracing), e.g., by grammar service 122; and
4. Problems that have associated grammar skills that the user has not mastered are automatically presented, until the user has mastered all of the grammar skills associated with available grammar problems, e.g., by grammar service 122.

In connection with sentences with subject-verb agreement errors, grammar service 122 may track grammar skills that are affected in various ways by the 10 sentence types listed above in the metadata stored in database 140.

### Corrections of Multiple-sentence Paragraphs

According to an embodiment, at least some of the problems in database 140 include data for multiple sentences that are configured to be presented all together to a user, i.e., in paragraph form. For example, grammar client 112 may cause each sentence in a paragraph to be highlighted in turn, allowing a user to determine whether the highlighted sentence includes a subject-verb agreement error. The user may be asked to complete various tasks for a particular sentence prior to moving on to another displayed sentence. For example, as discussed above, the user may be asked to complete one or more tasks of: 1) identifying whether a subject-verb agreement error exists, 2) locating the verb with the error, 3) identifying the nouns that determine the plurality of the subject, 4) choosing whether the subject is singular or plural, and 5) providing the correct verb.

Providing the user multiple sentences in the form of a paragraph gives the user a more realistic simulation of applying subject-verb agreement rules in the real-world setting of drafting and editing a paragraph. Users must be able to apply subject-verb agreement rules in the context of a multiple-sentence paragraph. Further, the paragraphs may contain multiple sentence types, multiple subject-verb agreement errors, and complex sentences with multiple potential locations for subject-verb agreement errors. Thus, completing paragraph-style problems can help better prepare such users to correctly apply subject-verb agreement rules in prose-style writing assignments and other writing opportunities.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

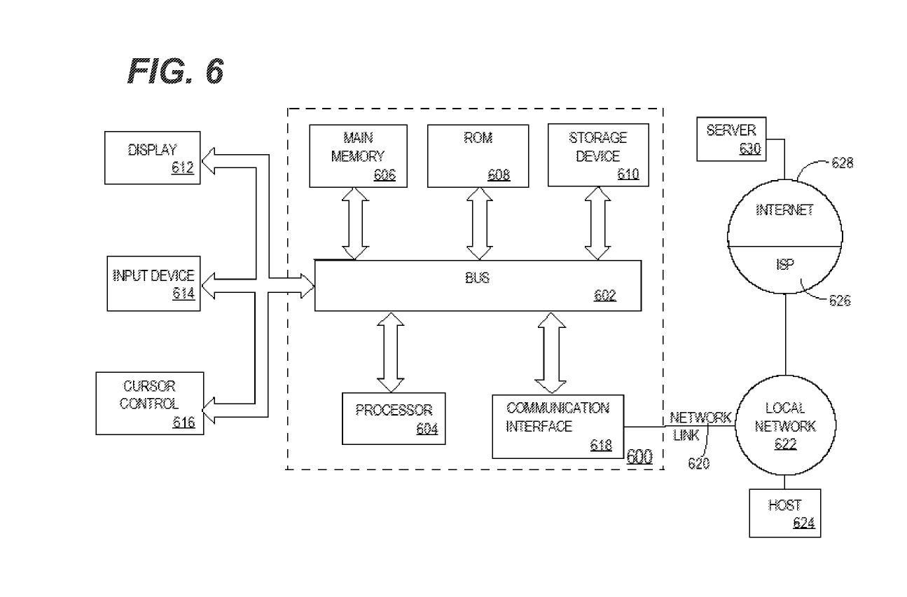

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or solid-state drive is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and subject-verb agreement selections to processor 604. Another type of user input device is cursor control 616, such as a mouse, a trackball, or cursor direction keys for communicating direction information and subject-verb agreement selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-executed method comprising:
displaying a graphical user interface that is generated by an automated grammar teaching system that is executing, at least in part, on a computing device;
depicting a natural language sentence on the graphical user interface;
receiving input information, from a user, which indicates whether the natural language sentence includes a subject-verb agreement error;
determining, by the automated grammar teaching system, whether the input information is correct;
in response to determining that the input information is incorrect for the natural language sentence, the automated grammar teaching system performing one or more of:
communicating that the input information is incorrect,
communicating a request for second input information indicating whether the natural language sentence includes a subject-verb agreement error, or
displaying remediation information for the natural language sentence.

2. The method of claim 1, further comprising, prior to the receiving, communicating one or more hints for the natural language sentence.

3. The method of claim 1, wherein the communicating that the input information is incorrect further communicates one or more hints for the natural language sentence.

4. The method of claim 1, wherein the remediation information comprises identifying one or more grammar elements of the natural language sentence.

5. The method of claim 4, wherein the one or more grammar elements include a complete subject, a core noun for determining whether the complete subject is singular or plural, and a verb.

6. The method of claim 4, wherein the identifying includes underlining and displaying names of the one or more grammar elements in the graphical user interface.

7. The method of claim 1, further comprising:
in response to determining that the second input information is correct for the natural language sentence, the automated grammar teaching system performing one or more of:
providing a subject-verb agreement rule explanation as applied for the natural language sentence,
communicating a request for third input information indicating a location of the subject-verb agreement error; or
communicating a request for third input information indicating a grammar rule being applied for the natural language sentence.

8. The method of claim 1, further comprising:
recording, in a set of historical data for the user, information about the depicted natural language sentence and the indicated input information;
based, at least in part, on the set of historical data for the user, selecting a second natural language sentence; and
displaying a second graphical user interface, at the computing device, that depicts the second natural language sentence.

9. A computer-executed method comprising:
displaying a graphical user interface, at a computing device, that is generated by an automated grammar teaching system that is executing, at least in part, on the computing device;
depicting a natural language sentence that includes a particular subject-verb agreement error that occurs at a particular location within the natural language sentence;
maintaining, by the automated grammar teaching system, data for identifying one or more accurate corrections for the particular subject-verb agreement error;
providing a control, in the graphical user interface, for receiving correction information for the particular subject-verb agreement error;
receiving, via the control from a user, information indicating a particular correction;
determining, based on the data, whether the particular correction is one of the one or more accurate corrections for the particular subject-verb agreement error;
in response to determining that the particular correction is the one or more accurate corrections for the particular subject-verb agreement error, communicating, via the graphical user interface, that the particular correction was successful.

10. The method of claim 9, wherein the data for identifying the one or more accurate corrections include one or more correct verbs that agree with a subject in the natural language sentence.

11. The method of claim 9, wherein the information indicating the particular correction includes selecting a verb in the natural language sentence having the particular subject-verb agreement error.

12. The method of claim 9, wherein the information indicating the particular correction includes selecting a core noun in the natural language sentence that determines whether a subject of the natural language sentence is singular or plural.

13. The method of claim 9, wherein the information indicating the particular correction includes a new verb to place at the particular location.

14. The method of claim 9, further comprising, prior to the receiving:
displaying a preview of a candidate correction applied to the natural language sentence, the candidate correction based on a position of a pointer in the graphical user interface.

15. The method of claim 14, further comprising, prior to the receiving:
showing a just-in-time tooltip for the candidate correction not being the one or more accurate corrections for the particular subject-verb agreement error.

16. The method of claim 9, wherein the depicting of the natural language sentence comprises the graphical user interface highlighting the natural language sentence within a paragraph, the highlighting by one or more of bolded text, font color, highlight color, a displayed symbol, or a displayed border.

17. The method of claim 16, wherein the communicating comprises the graphical user interface highlighting a different natural language sentence within the paragraph.

18. The method of claim 9, wherein the remediation information is based on one or more of:
academic literature about what students know about subject-verb agreement and the mistakes students make about subject-verb agreement;
cognitive learning models from subject matter experts and/or cognitive scientists; or a recorded set of historical data for the user.

19. A non-transitory computer-readable medium storing one or more sequences of instructions which, when executed by one or more processors, cause performing of:
displaying a graphical user interface, at a computing device, that is generated by an automated grammar teaching system that is executing, at least in part, on the computing device;
depicting a natural language sentence that includes a particular subject-verb agreement error that occurs at a particular location within the natural language sentence;
maintaining, by the automated grammar teaching system, data for identifying one or more accurate corrections for the particular subject-verb agreement error;
providing a control, in the graphical user interface, for receiving correction information for the particular subject-verb agreement error;
receiving, via the control from a user, information indicating a particular correction;
determining, based on the data, whether the particular correction is one of the one or more accurate corrections for the particular subject-verb agreement error;
in response to determining that the particular correction is the one or more accurate corrections for the particular subject-verb agreement error, communicating, via the graphical user interface, that the particular correction was successful.

20. The non-transitory computer-readable medium of claim 19, wherein the remediation information is based on one or more of:
academic literature about what students know about subject-verb agreement and the mistakes students make about subject-verb agreement;
cognitive learning models from subject matter experts and/or cognitive scientists; or
a recorded set of historical data for the user.
